(19) United States
(12) Patent Application Publication
(10) Pub. No.: US 2012/0080317 A1
(43) Pub. Date: Apr. 5, 2012

(54) ELECTRODEPOSITION OF CoNiP FILMS

(75) Inventors: Venkatram Venkatasamy, Edina, MN (US); Ming Sun, Eden Prairie, MN (US); Ibro Tabakovic, Edina, MN (US); Michael Xuefei Tang, Bloomington, MN (US)

(73) Assignee: SEAGATE TECHNOLOGY LLC, Scotts Valley, CA (US)

(21) Appl. No.: 12/894,238

(22) Filed: Sep. 30, 2010

(51) Int. Cl. B32B 9/00; C25D 9/04

(52) U.S. Cl. 205/50; 205/318

(57) ABSTRACT

A method of forming CoNiP on a substrate that includes the steps of placing a substrate in an electroplating bath, the electroplating bath containing an electroplating composition, the electroplating composition including: a nickel source; a cobalt source; and at least about 0.1 M phosphorus source; and applying a deposition current to the substrate, wherein application of the deposition current to the substrate will cause a CoNiP layer having a thickness of at least about 500 nanometers to be electrodeposited on the substrate.

### BACKGROUND

CoNiP is a cobalt based hard magnetic material with relatively high perpendicular coercivity and (BH)max. This makes CoNiP useful for a number of applications, including for example microelectromechanical systems (MEMS) applications. Thin (˜10 nanometer) CoNiP films having good magnetic properties have been reported in the literature, however thicker films (˜50 micrometer) have reported poor magnetic properties. Therefore, there remains a need for methods of fabricating thicker films of CoNiP that have good magnetic properties.

### BRIEF SUMMARY

A method of forming CoNiP on a substrate that includes the steps of placing a substrate in an electroplating bath, the electroplating bath containing an electroplating composition, the electroplating composition including: a nickel source; a cobalt source; and at least about 0.1 M phosphorus source; and applying a deposition current to the substrate, wherein application of the deposition current to the substrate will cause a CoNiP layer having a thickness of at least about 500 nanometers to be electrodeposited on the substrate.

A method of forming CoNiP on a substrate that includes the steps of placing a substrate in an electroplating bath, the electroplating bath containing an electroplating composition, the electroplating composition having a pH from about 3 to 4 and including: a nickel salt; a cobalt salt; and at least about 0.15 M NaH₂PO₂, KH₂PO₂, Ca(H₂PO₂)₂, Mg(H₂PO₂)₂, phosphoric acid, or combinations thereof; and applying a deposition current of at least about 8 mA/cm² to the substrate, wherein application of the deposition current to the substrate will cause CoNiP to be electrodeposited on the substrate to a thickness of at least about 5 micrometers.

An article that includes a substrate; and a layer of electrodeposited CoNiP on the substrate, wherein the CoNiP has a thickness of from about 25 μm to about 65 μm, and the CoNiP has a residual magnetic flux of at least about 0.2 Tesla.

These and various other features and advantages will be apparent from a reading of the following detailed description.

### BRIEF DESCRIPTION OF THE DRAWINGS

The disclosure may be more completely understood in consideration of the following detailed description of various embodiments of the disclosure in connection with the accompanying drawings, in which:

FIG. 1 is a schematic depiction of an illustrative electrodeposition system that can be utilized herein;

FIG. 2 is a graph showing M-H hysteresis that was obtained in Example 3; and

FIGS. 3A and 3B are scanning electron microscope (SEM) images of articles formed in Example 4 at 100× magnification (FIG. 3A) and 1500× magnification (FIG. 3B).

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

In the following description, reference is made to the accompanying set of drawings that form a part hereof and in which are shown by way of illustration several specific embodiments. It is to be understood that other embodiments are contemplated and may be made without departing from the scope or spirit of the present disclosure. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

“Include,” “including,” or like terms means encompassing but not limited to, that is, including and not exclusive.

Disclosed herein are methods of forming CoNiP on substrates and substrates including CoNiP having particular properties. The CoNiP can be characterized as a layer, film, deposit, or other similar structures. Disclosed methods are electrodeposition methods. Electrodeposition methods use electrical energy and potential gradients to deposit cations onto electrically conductive portions of a substrate. Methods can include steps of placing a substrate in an electroplating bath and applying a deposition current to the substrate.

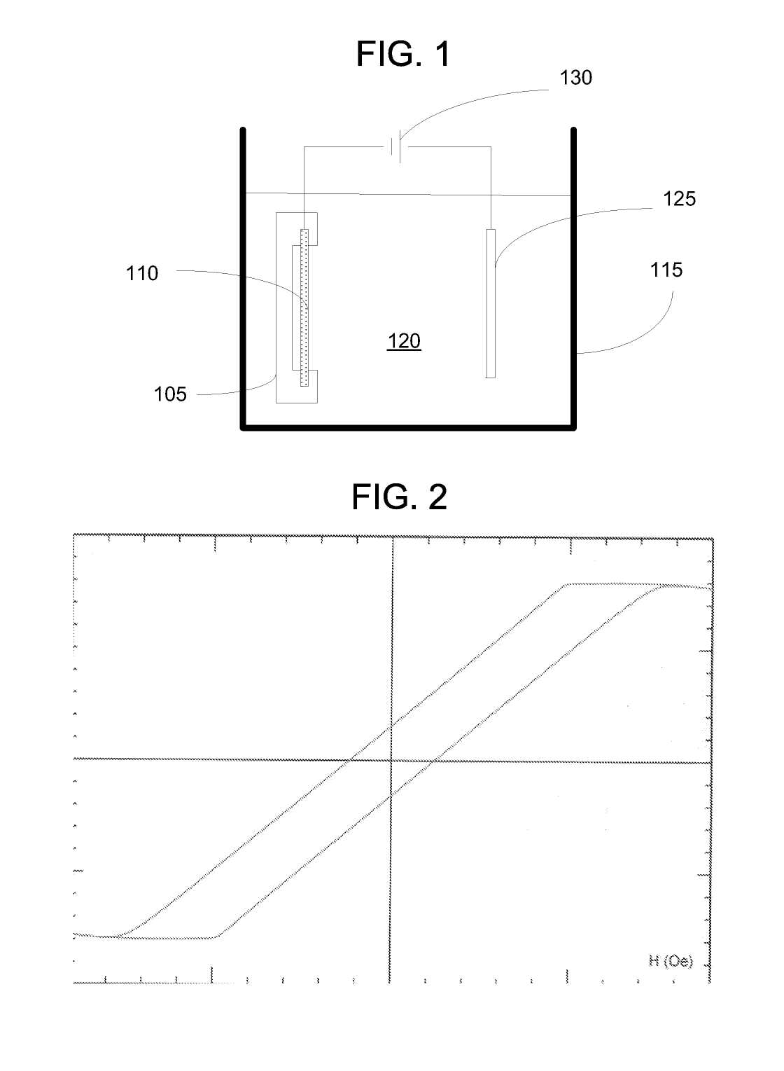

FIG. 1 is a schematic depiction of an exemplary system that can be utilized herein. The system shows a substrate 110 in an optional substrate holder 105. The substrate 110 can be electrically connected to a power supply 130, which can also be electrically connected to a counter electrode 125. The substrate 110 (along with the counter electrode 125) can be removably positioned within a plating bath 115 that can be filled with an electroplating composition 120. A system, such as that depicted in FIG. 1 can optionally be included in a larger system that can be utilized for electroplating. An example of such a larger system includes a SEMITOOL® CFD® Plating Tool (Applied Materials, Santa Clara, Calif.). Application of a current from the power supply 130 to the substrate 110 can cause material to be deposited out of the electroplating composition 120 onto the substrate 110.

Substrates that can be utilized herein can include anything upon which a CoNiP layer is desired to be formed. The substrate can be conductive, can have a conductive portion, or can have a conductive structure (a layer of material or otherwise) formed thereon. In embodiments, the substrate can be nonconductive and can have a conductive layer formed thereon. The conductive layer can function to conduct an electrical current, applied to some portion of the substrate, to the location where the CoNiP layer is to be electrodeposited. The conductive layer can also be referred to as a seed layer. A seed layer can be deposited for example, using various deposition techniques including sputter deposition. In embodiments, the seed layer may include, for example copper (Cu), gold (Au), ruthenium (Ru), nickel iron (NiFe) alloys, cobalt iron (CoFe) alloys, or cobalt nickel iron (CoNiFe) alloys. In embodiments, the seed layer may include alloys including, for example, NiFe (80:20), NiFe (45:55), and CoFe (65:35). In embodiments, the seed layer may include Cu. Substrates can also include an optional adhesion layer. An adhesion layer can function to promote the adhesion of the CoNiP material to the substrate. The adhesion layer can be formed on the seed layer (or on the substrate if no seed layer is present). The adhesion layer can be deposited for example, using various deposition techniques including supper deposition. In embodiments, the adhesion layer may include, for example tantalum (Ta), chromium (Cr), titanium (Ti), tantalum compounds, and titanium compounds. In embodiments, the adhesion layer may include, for example tantalum nitride (TaN), and titanium nitride (TiN). In embodiments, the adhesion layer may include Ta.

A substrate can also optionally be patterned. A patterned substrate will cause CoNiP to only be deposited on some of the substrate. A patterned substrate can be formed based on where the conductive material is placed on the substrate. A patterned substrate can also be formed by covering portions of the conductive surfaces of the substrate. The conductive surfaces can be covered using non-conductive materials. In embodiments, the conductive surfaces can be covered using a non-conductive tape for example.

Methods disclosed herein can include a step of placing a substrate in an electroplating bath that holds or contains an electroplating composition. An electroplating composition can include a nickel source, a cobalt source, and a phosphorus source. It should also be noted that an electroplating composition can include other optional components. An electroplating composition can also include water, for example deionized water. Electroplating compositions can be made, for example, by dissolving various components in water (for example deionized water).

In embodiments, an electroplating composition can include a nickel source. A nickel source can include one or more inorganic or nickel compounds that can be dissolved in water. In embodiments, a nickel source can include one or more inorganic nickel compounds (for example a nickel salt) that can be dissolved in water. Exemplary nickel sources can include for example nickel chloride (NiCl₂ or NiCl₂.6H₂O), nickel bromide (NiBr₂), nickel sulfate (NiSO₄), nickel sulfamate (Ni(SO₃NH₂).4H₂O), nickel tetrafluoroborate (Ni(BF₄)₂), and combinations thereof. In embodiments, NiCl₂ can be utilized. It should be noted that either anhydrous or hydrate forms of any inorganic compounds can be utilized. The electroplating composition can include various concentrations of the nickel source. In embodiments, the electroplating composition can include from 0.0.05 molar (M) to 0.4 M nickel source. In embodiments, the electroplating composition can include from 0.1 M to 0.3 M nickel source. In embodiments, the electroplating composition can include from 0.15 M to 0.25 M nickel source. In embodiments, the electroplating composition can include from 0.18 M to 0.22 M nickel source. In embodiments, the electroplating composition can include 0.2 M nickel source.

In embodiments, an electroplating composition can include a cobalt source. A cobalt source can include one or more inorganic or cobalt compounds that can be dissolved in water. In embodiments, a cobalt source can include one or more inorganic cobalt compounds (for example a cobalt salt) that can be dissolved in water. Exemplary cobalt sources can include cobalt chloride (CoCl₂ or CoCl₂.6H₂O), cobalt bromide (CoBr₂), cobalt sulfate (CoSO₄), and combinations thereof. In embodiments, CoCl₂ can be utilized. It should be noted that either anhydrous or hydrate forms of any inorganic compounds can be utilized. The electroplating composition can include various concentrations of the cobalt source. In embodiments, the electroplating composition can include from 0.05 M to 0.4 M cobalt source. In embodiments, the electroplating composition can include from 0.1 M to 0.3 M cobalt source. In embodiments, the electroplating composition can include from 0.15 M to 0.25 M cobalt source. In embodiments, the electroplating composition can include from 0.18 M to 0.22 M cobalt source. In embodiments, the electroplating composition can include 0.2 M cobalt source.

In embodiments, an electroplating composition can include similar amounts of nickel source and cobalt source. In embodiments, an electroplating composition can include amounts of nickel source and cobalt source that are within 0.3 M. In embodiments, an electroplating composition can include amounts of nickel source and cobalt source that are within 0.2 M. In embodiments, an electroplating composition can include amounts of nickel source and cobalt source that are within 0.1 M.

An electroplating composition also includes a phosphorus source. A phosphorus source can include one or more inorganic or phosphorus compounds that can be dissolved in water. In embodiments, a phosphorus source can include one or more inorganic phosphorus compounds that can be dissolved in water. Exemplary phosphorus sources can include for example phosphorus acids: phosphorus acid (H₃PO₃), phosphoric acid (H₃PO₄), hypophosphorus acid (H₃PO₂); salts of phosphorus acids: sodium dihydrogen phosphate (NaH₂PO₄), disodium hydrogen phosphate (Na₂HPO₄), sodium phosphate (Na₃PO₄), calcium dihydrogen phosphate (Ca(H₂PO₄), calcium hydrogen phosphate (CaHPO₄), tricalcium phosphate (Ca₃(PO₄)₂), potassium dihydrogen phosphate (KH₂PO₄), dipotassium hydrogen phosphate (K₂HPO₄), potassium phosphate (K₃PO₄), magnesium dihydrogen phosphate (Mg(H₂PO₄), magnesium hydrogen phosphate (MgHPO₄), trimagnesium phosphate (Mg₃(PO₄)₂), sodium phosphite (HNa₂O₃P), sodium hypophosphite (NaH₂PO₂), potassium hypophosphite (KH₂PO₂), calcium hypophosphite (Ca(H₂PO₂)₂), magnesium hypophosphite (Mg(H₂PO₂)₂); and combinations thereof. In embodiments, sodium hypophosphite (NaH₂PO₂), potassium hypophosphite (KH₂PO₂), calcium hypophosphite (Ca(H₂PO₂)₂), magnesium hypophosphite (Mg(H₂PO₂)₂) can be utilized. It should be noted that either anhydrous or hydrate forms of any inorganic compounds can be utilized.

The electroplating composition can include various concentrations of the phosphorus source. In embodiments, the electroplating composition can include at least 0.1 M phosphorus source. In embodiments, the electroplating composition can include at least 0.15 M phosphorus source. In embodiments, the electroplating composition can include at least 0.2 M phosphorus source. In embodiments, the electroplating composition can include at least 0.25 M phosphorus source. In embodiments, the electroplating composition can include at least 0.27 M phosphorus source.

Electroplating compositions utilized herein can include other optional components as well. In embodiments, electroplating compositions can include sodium chloride (NaCl), or potassium chloride (KCl). Sodium chloride, and other similar compounds like potassium chloride, can function to increase the conductivity of the electroplating bath. In embodiments where NaCl (or KCl) is included in an electroplating composition, it can have a concentration of at least 0.3 M. In embodiments, an electroplating composition can include at least 0.5 M NaCl or KCl. In embodiments, an electroplating composition can include 0.7 M NaCl or KCl. Electroplating compositions can also include additives such as, saccharin, saccharin salts, coumarin, thiourea, and lauryl sulfate for example. In embodiments, saccharin can be utilized. Saccharin, when utilized in an electroplating composition can function to relieve stress in the electroplating system. In embodiments where saccharin is utilized, it can have a concentration of at least 1 mM. In embodiments where saccharin is utilized, it can have a concentration of at least 2 mM. In embodiments where saccharin is utilized, it can have a concentration of less than 50 mM. In embodiments where saccharin is utilized, it can have a concentration of less than 20 mM. In embodiments where saccharin is utilized, it can have a concentration of less than 10 mM. In embodiments where saccharin is utilized, it can have a concentration between 2 mM and 8 mM. Other optional components can also be included in electroplating compositions utilized herein. For example, other additives can be added to increase the atomic percent of phosphorus that is deposited in the CoNiP layer.

The electroplating composition can also be characterized by its pH. In embodiments, the electroplating composition can have a pH of from 2.5 to 4. In embodiments, the electroplating composition can have a pH of from 3 to 4. In embodiments, the electroplating composition can have a pH of 3.

Once the substrate is placed in the electroplating bath, a deposition current can be applied to the substrate. As shown in FIG. 1, the substrate can be electrically connected to a power supply 130. Specific details about how the substrate is connected to the power supply and the counter electrode can depend at least in part on the particular system that is being utilized. The power supply can supply a direct current or a pulsed current to the counter electrode and metal ions that are dissolved in the electroplating composition can be reduced at the substrate and plate out on the substrate. The deposition current can be at least 6 milliamps per square centimeter (mA/cm²). In embodiments, the deposition current can be at least 8 mA/cm². In embodiments, the deposition current can be 10 mA/cm².

The time of application of the deposition current can depend at least in part on the desired thickness of the CoNiP layer being produced, and the type of substrate that it is being deposited on. In embodiments where a substrate is to be blanketed (there are not portions of the conductive portions of the substrate that are not to be coated with CoNiP), a 50 micrometer (μm) layer of CoNiP can be deposited in about 5 hours for example. In embodiments where a substrate is to be blanketed, a 25 μm layer of CoNiP can be deposited in about 2.5 hours. In embodiments were a substrate is to be blanked, a 10 μm layer of CoNiP can be deposited in about 1 hour. In embodiments were a substrate is to be pattered (there are portions of the conductive portions of the substrate that are not to be coated with CoNiP—this can be accomplished by covering portions of the conductive portions with a non-conductive material, for example a non-conductive tape), a 50 μm layer of CoNiP can be deposited in about 7 hours for example. In embodiments where a substrate is to be patterned, a 25 μm layer of CoNiP can be deposited in about 3.5 hours. In embodiments where a substrate is to be patterned, a 10 μm layer of CoNiP can be deposited in about 1.4 hours.

Application of the deposition current to the substrate, can cause a CoNiP layer to be formed on the substrate. The CoNiP layer can have various thicknesses. Such films can be thicker than previously produced CoNiP layers while still maintaining desirable magnetic properties. In embodiments, the CoNiP layer can have a thickness of at least 500 nanometers (nm). In embodiments, the CoNiP layer can have a thickness of at least 1 micrometer (μm). In embodiments, the CoNiP layer can have a thickness of at least 5 μm. In embodiments, the CoNiP layer can have a thickness of at least 25 μm. In embodiments, the CoNiP layer can have a thickness of at least 35 μm. In embodiments, the CoNiP layer can have a thickness of at least 50 μm. In embodiments, the CoNiP layer can have a thickness of from 25 μm to 65 μm.

The electrodeposited CoNiP can be magnetic. The magnetic properties of the CoNiP layer can be quantified by the residual magnetic flux (Br). In embodiments, the CoNiP layer can have residual magnetic flux of at least 0.2 Tesla (T). In embodiments, the CoNiP layer can have residual magnetic flux of at least 0.23 T. In embodiments, the CoNiP layer can have residual magnetic flux of at least 0.25 T. The magnetic properties of the CoNiP layer can also be quantified by the magnetic coercivity (H_{c}). In embodiments, the CoNiP layer can have a magnetic coercivity of at least 1.5 kilooersted (KOe). In embodiments, the CoNiP layer can have a magnetic coercivity of at least 2 KOe. In embodiments, the CoNiP layer can have a magnetic coercivity of at least 2.2 KOe. In embodiments, the CoNiP layer can have a magnetic coercivity of 2.4 KOe.

Methods can also include steps not discussed herein. In embodiments, the substrate with the electrodeposited layer can be subjected to further processing. In embodiments, electrodeposited CoNiP layers need not be subjected to further processing designed to smooth the CoNiP surface. For example, electrodeposited CoNiP layers need not be subjected to chemical mechanical planning (CMP) in order to obtain a CoNiP layer that is relatively smooth. This can be advantageous because it decreases processing steps necessary to form a CoNiP layer on a substrate.

Also disclosed herein are articles that include a substrate, as discussed above, with a layer of electrodeposited CoNiP thereon. The CoNiP layer can have thicknesses as discussed above. The CoNiP layer can have magnetic properties as discussed above. Articles disclosed herein can be a part of a larger article or device. In embodiments, articles that include a CoNiP layer as discussed above can be utilized in microelectromechanical systems (MEMS) devices. In embodiments, articles that include a CoNiP layer as discussed above can be utilized as a magnetic switch.

### EXAMPLES

### Materials and Methods

Unless otherwise noted, all chemicals were obtained from Aldrich and were used without further purification. All parts, percentages, ratios, etc. in the examples are by weight, unless noted otherwise.

### Example 1

A series of 5 μm CoNiP layers were deposited using different concentrations of the phosphorus source. An aqueous based electroplating composition was prepared with 47.5 g/L NiCl₂.6H₂O (0.2 M), 49.03 g/L CoCl₂.6H₂O (0.2 M), 24.7 g/L H₃BO₃ (0.4 M), 40.9 g/L NaCl (0.7 M) and 0.8 g/L (3.9 mM) sodium saccharin. Three different electroplating compositions were made using 12 g/L (0.11 M), 20 g/L (0.19 M) and 31 g/L (0.29 M) of NaH₂PO₂.H₂O.

The CoNiP layer was deposited on a 150 mm silicon (Si) wafer with a 2000 Å copper seed layer and a 500 Å tantalum adhesion layer. The substrate was configured within a SEMITOOL® CFD plating tool (Applied Materials, Santa Clara, Calif.). A deposition current of 1.65 A was applied for about 30 minutes. The resulting deposits were analyzed using Energy Dispersive X-ray (EDX) analysis using a JEOL JSM-6460LV (JEOL Ltd., Tokyo, Japan) to determine the composition of Co, Ni, and P and Vibrating Sample Magnetometer (VSM) analysis using a MicroMag 3900 (Princeton Measurement Corporation, Princeton, N.J.) to determine the residual magnetic flux (Br). The results of this analysis is shown in Table 1 below.

TABLE 1

| Phosphorus | Br | Cobalt | Nickel | Phosphorus |
|---|---|---|---|---|
| Source (g/L) | (Tesla) | (atomic %) | (atomic %) | (atomic %) |
| 12 | 0.20 | 85.29 | 9.50 | 5.21 |
| 20 | 0.23 | 85.40 | 9.21 | 5.39 |
| 31 | 0.23 | 85.14 | 9.23 | 5.63 |

### Example 2

A series of CoNiP layers were deposited using different electrodeposition currents. An electroplating composition including 47.5 g/L NiCl₂.6H₂O (0.2 M), 49.03 g/L CoCl₂.6H₂O (0.2 M), 24.7 g/L H₃BO₃ (0.4 M), 40.9 g/L NaCl (0.7 M), 0.8 g/L (3.9 mM) sodium saccharin, and 30 g/L (0.28 M) NaH₂PO₂.H₂O was prepared. The substrate and the electroplating system were as described above in Example 1. The deposition current was set at 8, 10, 16, and 20 mA/cm². EDX and VSM analysis was conducted as described above. The results of this analysis is shown in Table 2 below.

TABLE 2

| Current Density | Br | Cobalt | Nickel | Phosphorus |
|---|---|---|---|---|
| (mA/cm²) | (Tesla) | (atomic %) | (atomic %) | (atomic %) |
| 8 | 0.23 | 85.03 | 9.41 | 5.55 |
| 10 | 0.23 | 85.14 | 9.23 | 5.63 |
| 16 | 0.15 | 84.06 | 10.43 | 5.53 |
| 20 | 0.07 | 83.59 | 11.04 | 5.38 |

### Example 3

A series of CoNiP layers were deposited using electroplating compositions having different pHs. An electroplating composition including 47.5 g/L NiCl₂.6H₂O (0.2 M), 49.03 g/L CoCl₂.6H₂O (0.2 M), 24.7 g/L H₃BO₃ (0.4 M), 40.9 g/L NaCl (0.7 M), 0.8 g/L (3.9 mM) sodium saccharin, and 30 g/L (0.28 M) NaH₂PO₂.H₂O was prepared. The pH of three different quantities of this electroplating compositions were adjusted with a 10% HCl solution to a pH of 2.5, 3, and 4. The substrate and the electroplating system were as described above in Example 1. The deposition current was set at 10 mA/cm². EDX and VSM analysis was conducted as described above. The results of this analysis is shown in Table 3 below.

TABLE 3

| | Br | Cobalt | Nickel | Phosphorus |
|---|---|---|---|---|
| pH | (Tesla) | (atomic %) | (atomic %) | (atomic %) |
| 4 | 0.23 | 85.14 | 9.23 | 5.63 |
| 3 | 0.25 | 83.86 | 9.55 | 5.85 |
| 2.5 | 0.15 | 83.84 | 9.38 | 6.78 |

The graph from the out of plane measurement from the VSM analysis for the particular CoNiP layer in Example 3 that was formed at a pH of 3 can be seen in FIG. 2. The results of this analysis showed that the coercivity of the film was 2376 Oersted (Oe).

### Example 4

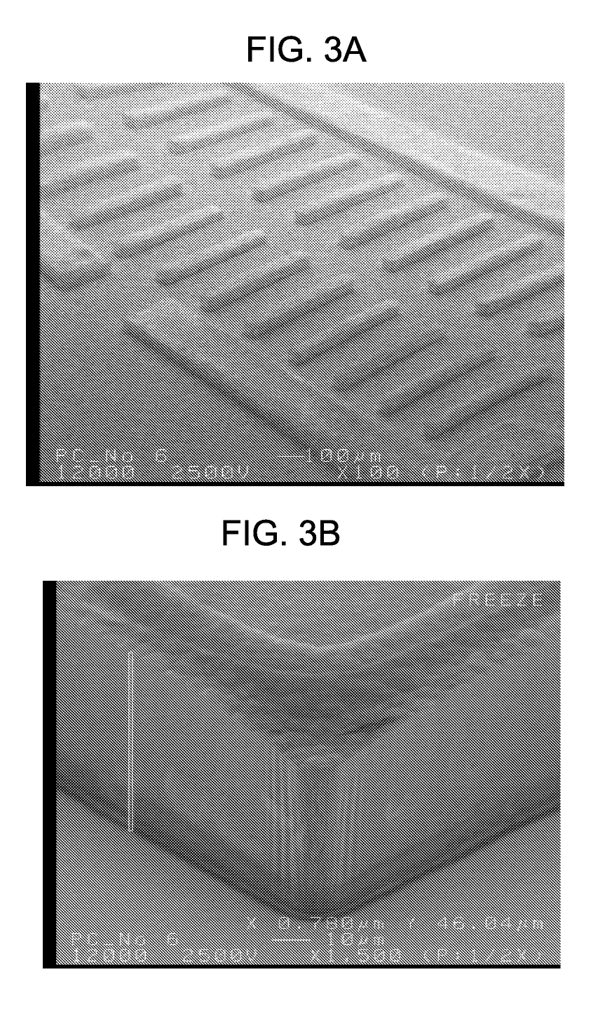

The conditions given in Example 3 for the pH 3 electroplating composition were utilized to form MEMS structures having 50 μm thicknesses—patterned plating was done as described in Example 3 for about 7 hours. Scanning electron microscope (SEM) images of the structures can be seen in FIG. 3A (100×) and FIG. 3B (1500×). Atomic force microscopy (AFM) was utilized to determine the RMS roughness, and it was found to be around 8 nm.

Thus, embodiments of ELECTRODEPOSITION OF CoNiP FILMS are disclosed. The implementations described above and other implementations are within the scope of the following claims. One skilled in the art will appreciate that the present disclosure can be practiced with embodiments other than those disclosed. The disclosed embodiments are presented for purposes of illustration and not limitation, and the present disclosure is limited only by the claims that follow.

What is claimed is:

1. A method of forming CoNiP on a substrate comprising the steps of:
placing a substrate in an electroplating bath, the electroplating bath containing an electroplating composition, the electroplating composition comprising:
a nickel source;
a cobalt source; and
at least about 0.1 M phosphorus source; and
applying a deposition current to the substrate,
wherein application of the deposition current to the substrate will cause a CoNiP layer having a thickness of at least about 500 nanometers to be electrodeposited on the substrate.

2. The method of claim 1, wherein the phosphorus source is chosen from a phosphorous acids.

3. The method of claim 1, wherein the phosphorus source is chosen from sodium hypophosphite (NaH₂PO₂), potassium hypophosphite (KH₂PO₂), calcium hypophosphite (Ca(H₂PO₂)₂), magnesium hypophosphite (Mg(H₂PO₂)₂), or combinations thereof.

4. The method of claim 1, wherein the phosphorus source has a concentration of at least about 0.25M

5. The method of claim 1, wherein the nickel source is chosen from NiCl₂, NiBr₂, NiSO₄, Ni(SO₃NH₂).4H₂O, Ni(BF₄)₂, and combinations thereof.

6. The method of claim 1, wherein the cobalt source is chosen from CoCl₂, CoBr₂, CoSO₄, and combinations thereof.

7. The method of claim 1, wherein the electroplating bath further comprises at least about 0.5 M NaCl.

8. The method of claim 1, wherein the electroplating bath further comprises at least about 1 mM saccharin.

9. The method of claim 8, wherein the electroplating bath has a saccharin concentration of less than about 20 mM.

10. The method of claim 1, wherein the electroplating bath has a pH of about 3.

11. The method of claim 1, wherein the deposition current is at least about 8 mA/cm².

12. The method of claim 1, wherein the deposition current is about 10 mA/cm².

13. The method of claim 1, wherein the CoNiP film has a thickness of at least about 1 micrometer.

14. The method of claim 1, wherein the CoNiP film has a thickness of about 5 micrometers.

15. A method of forming CoNiP on a substrate comprising the steps of:
placing a substrate in an electroplating bath, the electroplating bath containing an electroplating composition, the electroplating composition having a pH from about 3 to 4 and comprising:
a nickel salt;
a cobalt salt; and
at least about 0.15 M NaH₂PO₂, KH₂PO₂, Ca(H₂PO₂)₂, Mg(H₂PO₂)₂, phosphoric acid, or combinations thereof; and
applying a deposition current of at least about 8 mA/cm² to the substrate,
wherein application of the deposition current to the substrate will cause CoNiP to be electrodeposited on the substrate to a thickness of at least about 5 micrometers.

16. The method of claim 15, wherein the nickel salt is chosen from about 0.1 to 0.3 M NiCl₂, NiBr₂, and combinations thereof and the cobalt salt is chosen from about 0.1 M to 0.3 M CoCl₂, CoBr₂, and combinations thereof.

17. The method of claim 15, wherein the NaH₂PO₂, KH₂PO₂, Ca(H₂PO₂)₂, Mg(H₂PO₂)₂, or phosphoric acid is present at least about 0.25 M.

18. The method of claim 15, wherein the CoNiP layer has a thickness of at about 25 μm.

19. An article comprising:
a substrate; and
a layer of electrodeposited CoNiP on the substrate, wherein the CoNiP has a thickness of from about 25 μm to about 65 μm, and the CoNiP has a residual magnetic flux of at least about 0.2 Tesla.

20. The article according to claim 19, wherein the CoNiP has a thickness of at least about 35 μm and a residual magnetic flux of at least about 0.25 Tesla.
